(19) United States
(12) Patent Application Publication
(10) Pub. No.: US 2013/0228161 A1
(43) Pub. Date: Sep. 5, 2013

(54) WIND RESISTANT GRILLING APPARATUS

(71) Applicant: MALLIK AHMED, Columbus, GA (US)

(72) Inventor: MALLIK AHMED, Columbus, GA (US)

(21) Appl. No.: 13/409,361

(22) Filed: Mar. 1, 2012

(51) Int. Cl. A47J 37/07

(52) U.S. Cl. 126/25 R; 126/15 R

(57) ABSTRACT

A grilling apparatus having one or both of a rear wind diverting structure and a front side and/or rear side air inlet which will cause a positive pressure differential to be maintained within the grilling apparatus even when subjected to high wind conditions.

### FIELD OF THE INVENTION

The present invention relates to outdoor grilling apparatuses.

### BACKGROUND OF THE INVENTION

A conventional outdoor grilling apparatus 2 heretofore known in the art is illustrated in FIGS. 1-3. The prior art grilling apparatus 2 comprises: a housing structure 4 having a firebox 6 therein; a firebox inner wall 8; an outer insulating wall 10; an inlet air opening 12 formed in the bottom 14 of the outer wall 10; and corresponding air openings 16 which are formed in the bottom portion of the firebox inner wall 8 and are in fluid communication with the bottom opening 12 of the outer wall.

The prior art grilling apparatus 2 further comprises: one or more burner elements 18 extending from side-to-side (i.e., from left to right) in the lower portion of the firebox 6; a cooking grate or other food support structure 20 which is removably positionable above the burner element(s) 18; a lid or other cover 22 which is typically pivotably attached to the housing structure 4 for opening and closing the top of the firebox 6; and a rear exhaust opening 24 which extends horizontally across the back of the grilling apparatus 2 when the cover 22 is closed.

The rear exhaust opening 24 is positioned at an elevation which is higher than the elevation of the food support structure 20. In addition, the rear exhaust opening 24 is formed between the upper end 26 of a vertical back wall 28 of the housing structure 4 and a rearward-most back edge 30 of the cover 22. The back edge 30 of the cover 22 is substantially in vertical alignment with or slightly rearward of the upper end 26 of the vertical back wall 28 of the housing structure 4 such that a line 32 running through points 26 and 30 as illustrated in FIG. 2 extends at an angle 34 which is typically in a range of from 0° to about ⁺5° from vertical. Consequently, the rear exhaust opening 24 defined between the points 26 and 30 faces in a direction 36, perpendicular to line 32, which is approximately horizontal.

Another example of a conventional prior art grilling apparatus 50 is illustrated in FIGS. 4-6. The prior art grilling apparatus 50 is similar to grill 2 except that the prior art grill 50 has: a single-walled firebox 52 having a substantially flat bottom 54; a plurality of burner elements 56 extending from front-to-back in the firebox 52 beneath the cooking grate or other food support structure 58; and a series of inlet air openings 60 in the bottom 54 of the firebox which extend from side-to-side (i.e., left to right) and are substantially perpendicular to and substantially centered beneath the burner elements 56. As with the conventional grill 2, the conventional grill 50 also has a rear exhaust opening 62 formed between a back-side edge 64 of the cover 66 and a backwall upper edge 68 of the grill housing 70 such that the rear exhaust opening 62 faces rearwardly in a direction 72 which is approximately horizontal.

A third example of a conventional prior art grilling apparatus 80 is illustrated in FIGS. 7-9. The grilling apparatus 80 comprises the prior art grill 50 positioned on top of a grill cart 82 having wheels, casters or rollers 84 for moving the grilling apparatus 80. The grill car 82 includes a cabinet 86 wherein the burner fuel canister is typically housed. During operation, the cabinet 86 is closed so that air for the air inlet openings 60 in the bottom 54 of the grill firebox 52 enters the cabinet 86 through cracks, gaps, side ventilation holes, or downwardly extending side louvers 88.

For an outdoor grilling apparatus 2, 50, or 80 of the type shown in FIGS. 1-9, industry wind certification tests require that the grill burner(s) 18 or 56 must remain lit, with the grill cover 22 or 66 open, when exposed to a 10 mile per hour wind. However, even though the burners 18 or 56 of the prior art grill 2 or 50, or 80 will manage to remain ignited, the performance and consistency of a prior art grilling apparatus 2, 50, or 88 when exposed to winds of 5 miles per hour or more or is severely compromised.

Regardless of whether the cover 22 or 66 is open or closed, a wind of 5 miles per hour or more will commonly cause a pressure reversal in the grill 2, 50, or 80 such that a greater pressure will exist above rather than below the burner element(s) 18 or 56. The pressure reversal then causes cold air flow to downwardly through the food support structure 20 or 60 so that: (a) a significant amount of hot flue gas and heat energy flows out of the bottom air opening 12 or 60 and is lost, (b) the cooking temperature at the food support structure 20 or 58 is significantly reduced and is very inconsistent, and (c) an adequate cooking temperature at the food support grate 20 or 58 cannot be consistently maintained, even if the amount of fuel delivered to the burner(s) is significantly increased.

FIGS. 2, 5, and 8 illustrate the effect of a horizontal front wind 90 of 5 miles per hour or greater on the operation of the conventional grilling apparatuses 2, 50, and 80. As shown by the air and gas circulation arrows 92 provided in FIGS. 2, 5, and 8, the front wind 90 enters front gaps 25 or 65, for example, between the grill housing and the cover. In addition, the horizontal flow of the wind 90 across the bottom 14 or 54 of the firebox 4 or 52 or across the side vents 88 of a grill cabinet 82 can also create a negative pressure condition at the air inlet opening 12 or 60 below the burner element(s) 18 or 56. Consequently, a pressure reversal is created such that (a) cold air flows downwardly through at least the forward portion of the cooking grate 20 or 58 and (b) hot combustion gases and heat energy flow out of the air inlet 12 or 60.

Similarly, FIGS. 3, 6, and 9 illustrate the effect of a horizontal rear wind 95 of 5 miles per hour or greater on the conventional grilling apparatuses 2, 50, and 80. As shown by the air and gas circulation arrows 96, the rear wind forcefully enters the rear exhaust opening 24 or 62 and can also create a negative pressure condition at the bottom air inlet 12 or 60. Consequently, cold air flows downwardly through substantially the entire cooking grate 20 or 58.

Consequently, a need exists for a wind resistant grilling apparatus wherein the apparatus will not only remain lit when subjected to winds of 10 miles per hour in accordance with industry standards, but will also continue to maintain a higher pressure below rather than above the burner(s) so that combustion gases will continue to flow upwardly through the food support grate and out of the rear exhaust opening.

### SUMMARY OF THE INVENTION

The present invention provides an improved grilling apparatus and method which satisfy the needs and alleviate the problems discussed above. By way of example, but not by way of limitation, the present invention can be used to significantly improve the performance of substantially any cooking grill of the type comprising: a housing structure having therein an upwardly facing firebox; a cover for opening and closing the firebox; a food support structure or rotisserie positionable in and/or over the upper end of the fire box; a fuel delivery or placement structure (preferably a burner element) in the firebox below the elevation of the food support structure; an air inlet provided in an outermost wall of the housing structure for receiving outside air such that the outside air flowing into the air inlet will be delivered into the firebox; and a rear exhaust opening which is present when the cover is closed and is located preferably at an elevation above that of the food support structure.

In one aspect, the inventive improvement can comprise the air inlet being comprised of one or more openings in the outermost wall oriented and positioned forwardly, rearwardly, or both forwardly and rearwardly of the fuel delivery or placement structure in a manner such that, when (a) the grilling apparatus is operated at an average highest normal cooking energy input level for the grilling apparatus, (b) the cover is closed, and (c) a 10 mile per hour front wind is blowing against and directly perpendicular to the front side of the grilling apparatus, a greater pressure will exist in the firebox elevationally below the fuel delivery or placement structure than will exist in the firebox above the fuel delivery or placement structure.

In another aspect, the inventive improvement can additionally or alternatively comprise the air inlet of the housing structure being comprised of one or more openings in the outermost wall facing forwardly, rearwardly, or both forwardly and rearwardly at an orientation within a range of plus or minus 45° from horizontal.

In another aspect wherein the fuel delivery structure comprises a burner element having a plurality of gas discharge ports, the inventive improvement can additionally or alternatively comprise the air inlet of the housing structure being comprised of one or more openings positioned in an upwardly extending portion of a front side of the housing structure, in an upwardly extending portion of a rear side of the housing structure, or in both an upwardly extending portion of the front side and an upwardly extending portion of the rear side of the housing structure, and the one or more opening of the air inlet being positioned elevationally lower than gas discharge ports, such that when (a) the grilling apparatus is operated at a highest cooking setting for the burner element, (b) the cover is closed, and (c) a 10 mile per hour front wind is blowing against and directly perpendicular to the front side of the grilling apparatus, a greater pressure will exist in the firebox below the gas discharge ports than will exist in the firebox above the gas discharge ports.

Alternatively or in addition, the inventive improvement can comprise a wind diverting structure which extends upwardly and outwardly on a rear side of the housing structure in a manner effective such that the rear exhaust opening is defined between an outer end of the wind diverting structure and an edge of the cover and, when (a) the grilling apparatus is operated at the highest cooking setting for the burner element, (b) the cover is closed, and (c) a 10 mile per hour wind is blowing against and directly perpendicular to the rear side of the grilling apparatus, a greater pressure will exist in the firebox elevationally below the fuel delivery or placement structure than will exist in the firebox above the fuel delivery or placement structure.

In another aspect wherein the grilling apparatus comprises a housing structure having an upwardly facing firebox and a cover for opening and closing the firebox, and wherein the grilling apparatus has a front side and rear side and, when the cover is closed, the grilling apparatus has a rear exhaust opening, the inventive improvement can comprise: a wind diverting structure which extends upwardly on a rear side of the housing structure at an outward angle; the outward angle being in a range of from about 20° to about 60° from vertical; and the rear exhaust opening being defined between an outer end of the diverting structure and an edge of the cover such that the rear exhaust opening faces upwardly at a rearward angle of from about 10° to about 60° from vertical.

In another aspect wherein the grilling apparatus comprises (i) a housing structure having therein an upwardly facing firebox, (ii) a cover for opening and closing the firebox, and (iii) a fuel delivery or placement structure in the firebox, and wherein the grilling apparatus has a front side and a rear side and, when the cover is closed, the grilling apparatus has a rear exhaust opening, the improvement can comprise: (a) an inlet air receiving structure beneath a bottom of the housing structure, (b) at least one opening provided in the bottom of the housing structure such that the opening is in fluid communication with the firebox and with the inlet air receiving structure and (c) one or more front, rear, or both front and rear air inlets in the inlet air receiving structure for receiving outside air in a manner effective such that, when the grilling apparatus is operated at an average highest normal cooking energy input level for the grilling apparatus, the cover is closed, and a 10 mile per hour wind is blowing against and directly perpendicular to the front side of the grilling apparatus, a greater pressure will exist in the firebox elevationally below the fuel delivery or placement structure than will exist in the firebox above the fuel delivery or placement structure.

Examples of inlet air receiving structures include, but are not limited to, duct structures and box structures such as, e.g., stationary cabinets and mobile cart cabinets.

Further aspects, features, and advantages of the present invention will be apparent to those of ordinary skill in the art upon examining the accompanying drawings and upon reading the following detailed description of the preferred embodiments.

### BRIEF DESCRIPTION OF THE DRAWINGS

FIG. 1 is a cutaway perspective side view of a prior art grilling apparatus 2.

FIG. 2 is a cutaway elevational side view of the prior art cooking grill 2 operating under front wind conditions.

FIG. 3 is a cutaway elevational side view of the prior art cooking grill 2 operating under rear wind conditions.

FIG. 4 is a cutaway perspective side view of a prior art grilling apparatus 50.

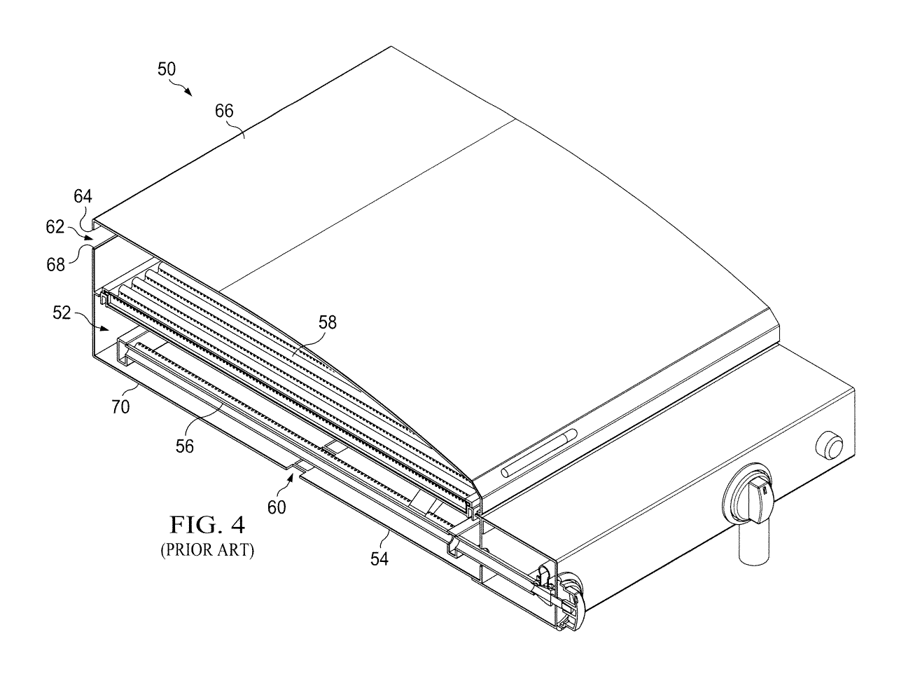

FIG. 5 is a cutaway elevational side view of the prior art cooking grill 50 operating under front wind conditions.

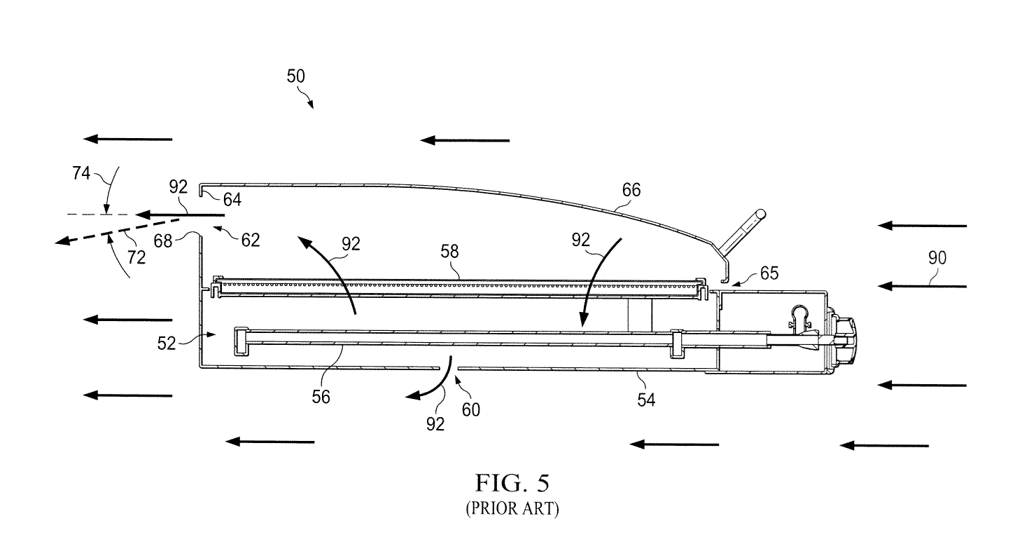

FIG. 6 is a cutaway elevational side view of the prior art cooking grill 50 operating under rear wind conditions.

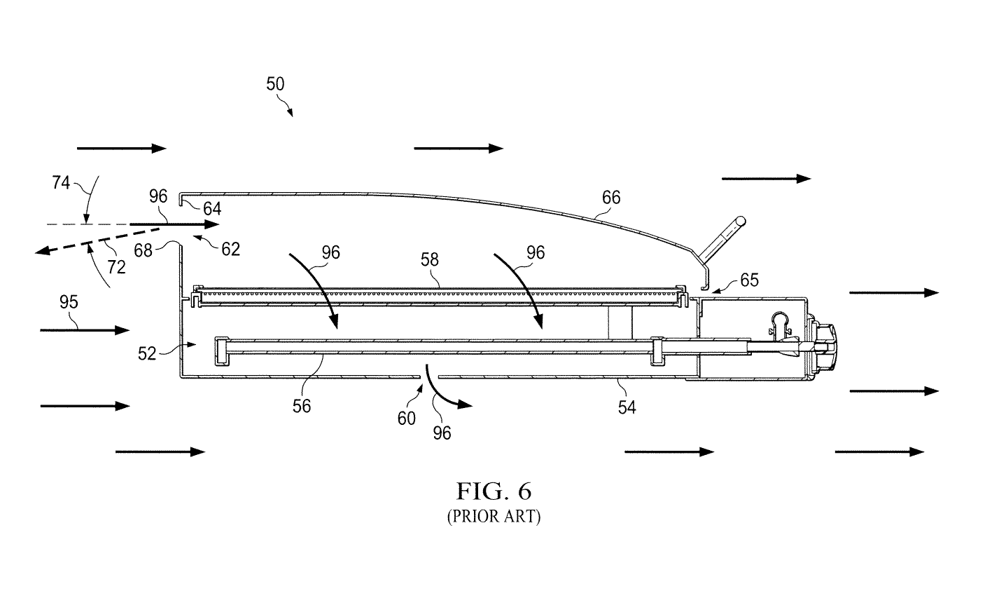

FIG. 7 is a cutaway perspective view of a prior art grilling apparatus 80.

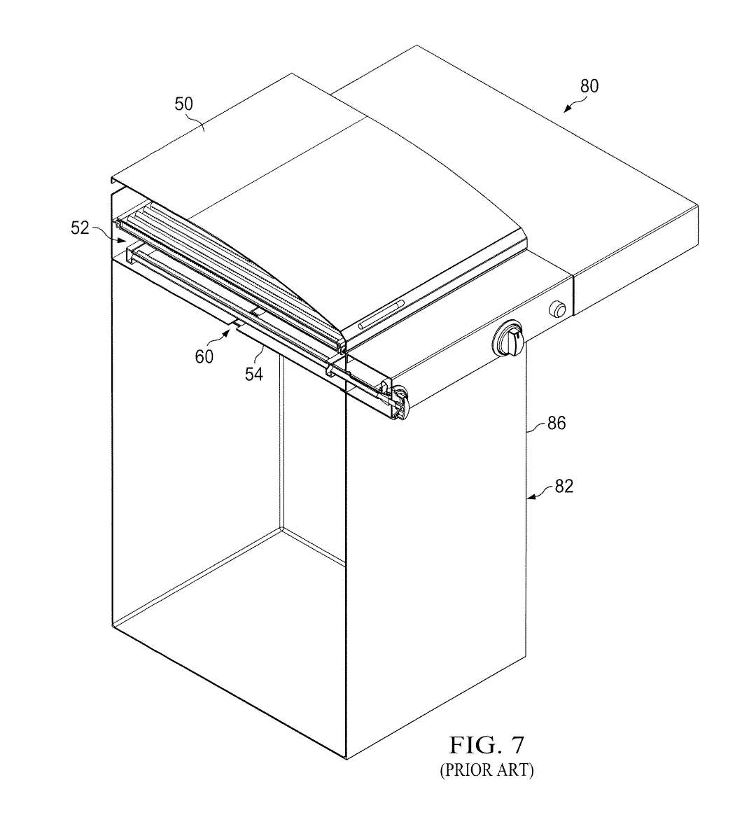

FIG. 8 is a cutaway elevational side view of the prior art cooking grill 80 operating under front wind conditions.

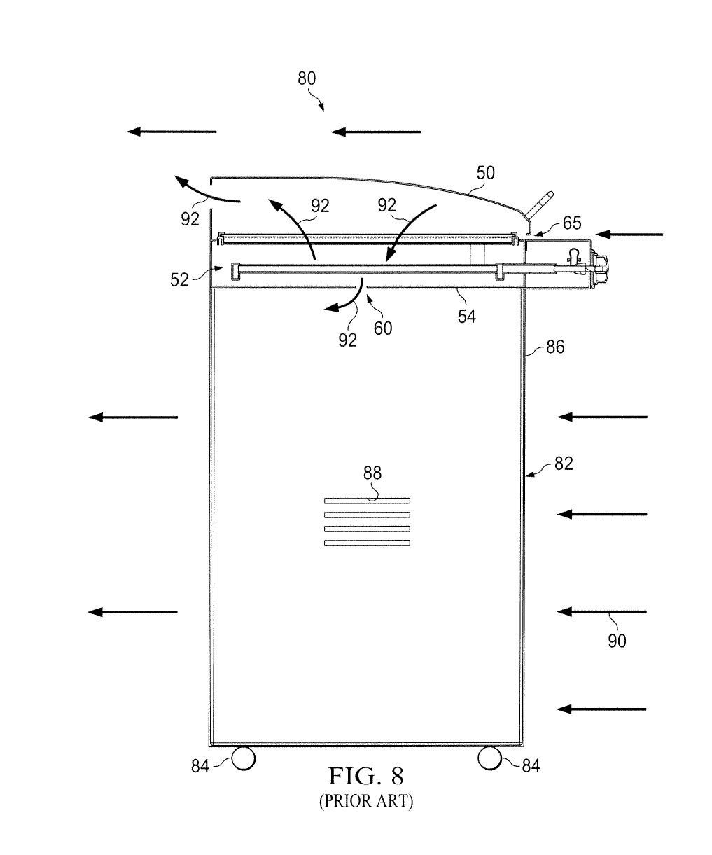

FIG. 9 is a cutaway elevational side view of the prior art cooking grill 80 operating under rear wind conditions.

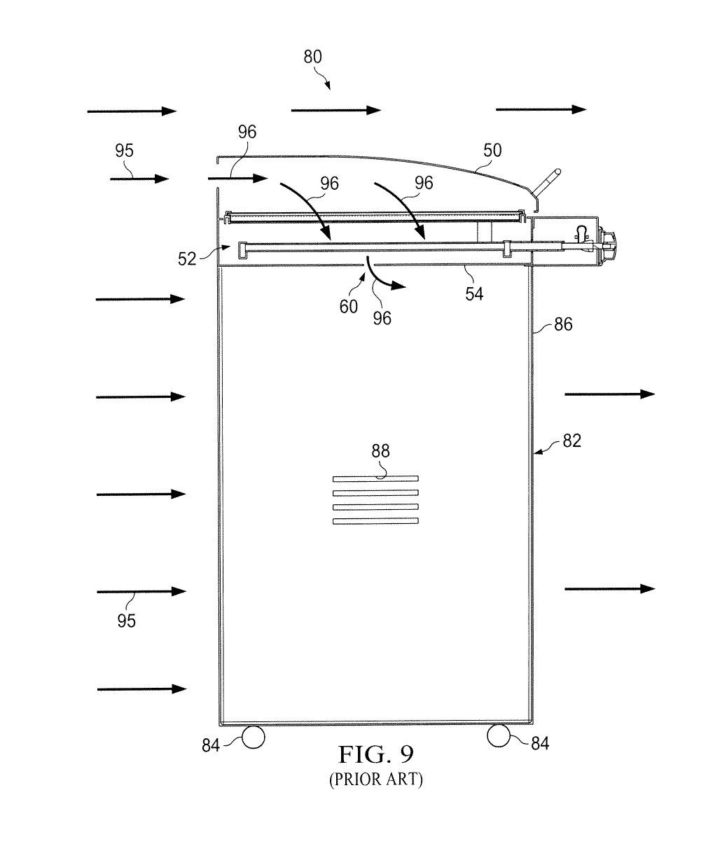

FIG. 10 is a cutaway perspective view of an embodiment 100 of the inventive grilling apparatus.

FIG. 11 is a cutaway elevational side view of the inventive cooking grill 100 operating under front wind conditions.

FIG. 12 is a cutaway elevational side view of the inventive cooking grill 100 operating under rear wind conditions.

FIG. 13 is a cutaway perspective view of an embodiment 200 of the inventive grilling apparatus.

FIG. 14 is a cutaway elevational side view of the inventive cooking grill 200 operating under front wind conditions.

FIG. 15 is a cutaway elevational side view of the inventive cooking grill 200 operating under rear wind conditions.

FIG. 16 is a cutaway perspective view of an embodiment 300 of the inventive grilling apparatus.

FIG. 17 is a cutaway elevational side view of the inventive cooking grill 300 operating under front wind conditions.

FIG. 18 is a cutaway elevational side view of the inventive cooking grill 300 operating under rear wind conditions.

FIG. 19 is a cutaway perspective view of an embodiment 400 of the inventive grilling apparatus.

FIG. 20 is a cutaway elevational side view of the inventive cooking grill 400 operating under front wind conditions.

FIG. 21 is a cutaway elevational side view of the inventive cooking grill 400 operating under rear wind conditions.

FIG. 22 is a cutaway perspective view of an embodiment 500 of the inventive grilling apparatus.

FIG. 23 is a cutaway elevational side view of the inventive cooking grill 500 operating under front wind conditions.

FIG. 24 is a cutaway elevational side view of the inventive cooking grill 500 operating under rear wind conditions.

FIG. 25 is a cutaway perspective view of an embodiment 600 of the inventive grilling apparatus.

FIG. 26 is a cutaway elevational side view of the inventive cooking grill 600 operating under front wind conditions.

FIG. 27 is a cutaway elevational side view of the inventive cooking grill 600 operating under rear wind conditions.

FIG. 28 is a cutaway perspective view of an embodiment 700 of the inventive grilling apparatus.

FIG. 29 is a cutaway elevational side view of the inventive cooking grill 700 operating under front wind conditions.

FIG. 30 is a cutaway elevational side view of the inventive cooking grill 700 operating under rear wind conditions.

### DETAILED DESCRIPTION OF THE PREFERRED EMBODIMENTS

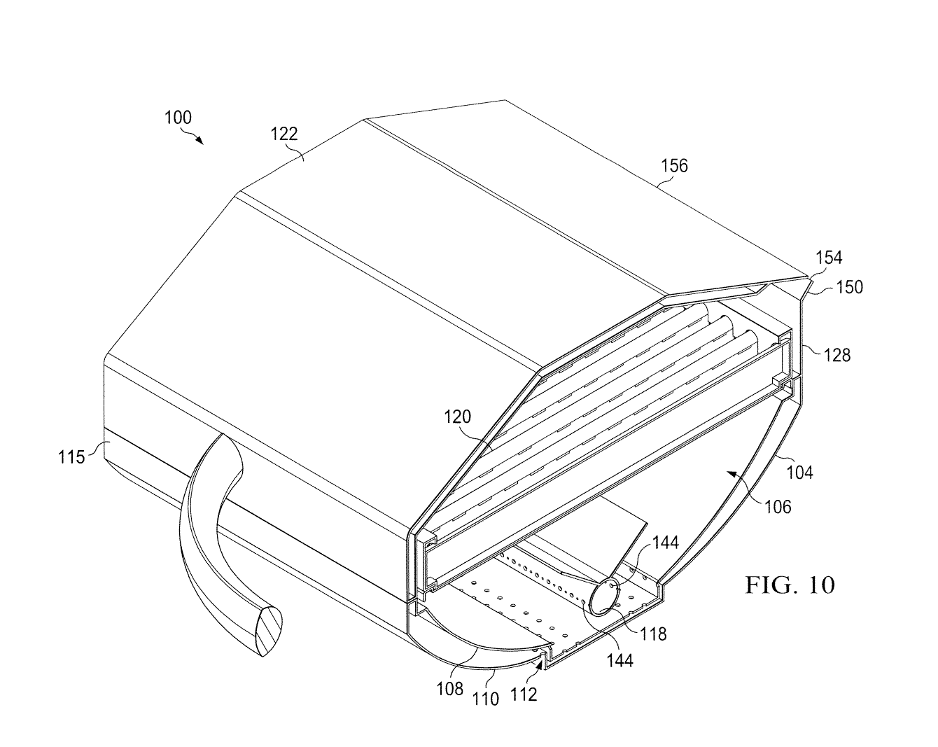

An embodiment 100 of the inventive improved grilling apparatus is depicted in FIGS. 10-12. The grilling apparatus 100 comprises a housing structure 104 which includes: a firebox 106 within the housing structure 104; a firebox inner wall 108; an outer insulating wall 110 which covers at least most of the exterior of the inner wall 108; and an upwardly extending (preferably substantially vertical) back wall 128. The grilling apparatus 100 and the housing structure 104 thereof have a front side 115 and rear side 135.

As used herein and in the claims, the terms front side and rear side of the housing structure 104 respectively refer to any surface or other feature of the housing structure 104 which can be seen in an elevational front view or an elevational rear view of the grill. Thus, the front side of the housing structure 104 includes the bottom vertical segment 136 of the outer wall 110 and the upwardly curving portion 138 which curves upwardly and forwardly from the upper end of the bottom vertical segment 136. As used herein and in the claims, the vertical segment 136 and the upwardly curving portion 138 are each “upwardly extending” portions of the front side 115 of the housing structure 104.

Similarly, the rear side 135 of the inventive grilling apparatus 100 includes the bottom vertical segment 140 of the outer wall 110 and the upwardly curving portion 142 of the outer wall 110 which curves upwardly and outwardly from the upper end of the bottom rear vertical segment 140. The vertical segment 140 and the upwardly curving portion 142 are each “upwardly extending” portions of the rear side 135 of the housing structure 104.

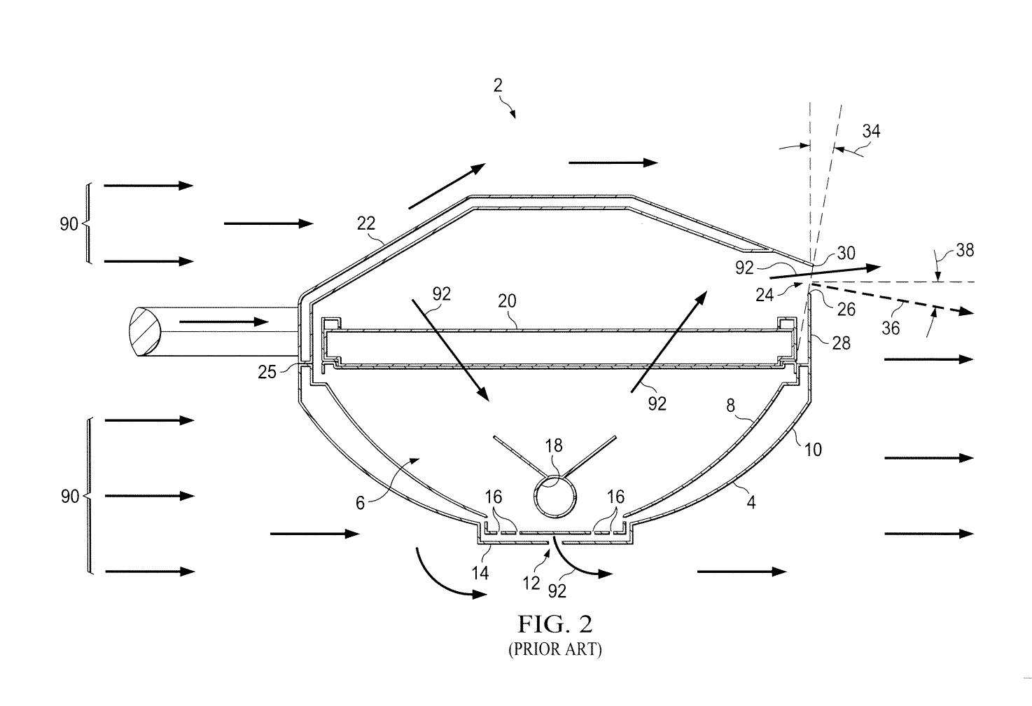

In addition, the inventive grilling apparatus 100 further comprises: one of more fuel delivery or fuel placement structures 118 installed within a lower portion of the firebox 106; a cooking grate or other food support structure 120 which is removably positionable above the fuel delivery or fuel placement structure(s) 118; and a cover 122 which is preferably pivotably attached to the housing structure 104 for opening and closing the firebox 106. The fuel delivery or fuel placement structure(s) 118 can comprise (a) one or more gas burner elements, (b) a grate or perforated plate or bin for supporting a solid fuel such as, e.g., charcoal briquettes or wood pellets, or (c) generally any other type of fuel delivery or fuel placement structure used in the art. Examples of preferred fuel delivery structure(s) 118 include, but are not limited to, one or more tube burner element(s), pan burner element(s), or other of gas burner element(s). FIG. 2 illustrates the use of a tube burner element 118 which can have one, two, or more rows of gas discharge ports 144.

The food support structure 120 used in the inventive grilling apparatus 100 can be a convection grate, an infrared cooking grate or grate assembly, a combination thereof, or any other type of food support structure used in the art. In addition, the food support structure 120 can be a single piece structure or can comprise a combination of two or more elements (e.g., a food support rib or grate structure positioned over a radiating plate or element).

In contrast to the prior art grill 2 described above, the air inlet opening(s) 112 of the inventive grilling apparatus 100 preferably comprise one or more slots or one or more rows of apertures which extend across the front side 115 of the outer wall 110 of the housing structure 104 and/or across the rear side 135 of the outer wall 110 of the housing structure 104. The air inlet opening(s) 112 in the inventive apparatus 100, therefore, can be located in the upwardly extending vertical bottom segment 136 of the front side 115, the upwardly extending curved segment 138 of the front side 115, the upwardly extending vertical bottom segment 140 of the rear side 135, and/or the upwardly extending curved segment 142 of the rear side 135. The air inlet opening(s) 112 will preferably be located in the upwardly extending vertical bottom segment 136 and/or the upwardly extending curved segment 138 of the outer wall of the front side 115. In addition, regardless of whether the air inlet 112 opening(s) is/are provided in the front side 115, the rear side 135, or a combination thereof, the air inlet opening(s) 112 will preferably be located below the fuel delivery or fuel placement structure(s) 118, or at least below the elevational of the gas discharge ports 144 in the case of a gas burner element, so as to prevent flame failure or inadequate combustion.

As also seen in FIGS. 10-12, the air inlet opening(s) 112 provided in the front side 115 of the outer insulating wall 110 is/are in fluid communication with a gap 146 which is formed between the firebox inner all 108 and the outer insulating wall 110. Consequently, the primary combustion air, as in the case of a solid fuel grill, or secondary combustion air, as in the case of most gas fuel grills, which is received through the inlet air opening(s) 112 will flow through the air flow gap 146 and then into the firebox 106 via one or more openings 116 provided through the firebox inner wall 108. The inner wall opening(s) 116 is/are preferably located elevationally below the fuel delivery or fuel placement structure 118, or at least elevationally below the fuel discharge ports 144 in the case of a gas burner element.

The air inlet opening(s) 112 will preferably be located in the front side 115 and/or the rear side 135, most preferably in the front side 115, of the outer wall 110 of the housing structure 104 such that, when (a) the cooking grill 100 is operated at an average highest normal energy input level for the cooking grill, (b) the cover 122 is closed (and preferably also when the cover 122 is open), and (c) a 10 mile per hour front wind is blowing against and directly perpendicular to the front side 115 of the inventive grill 100, a greater pressure will exist in the firebox 106 elevationally below the fuel delivery or fuel placement structure(s) 118 than will exist above the fuel delivery or fuel placement structure(s) 118. Consequently, when the inventive grill apparatus is operated under these conditions and each fuel delivery or fuel placement structure 118 is a gas burner element, the pressure in the firebox 106 below the gas discharge ports 144 will be greater than the pressure in the firebox 106 above the gas discharge ports 144.

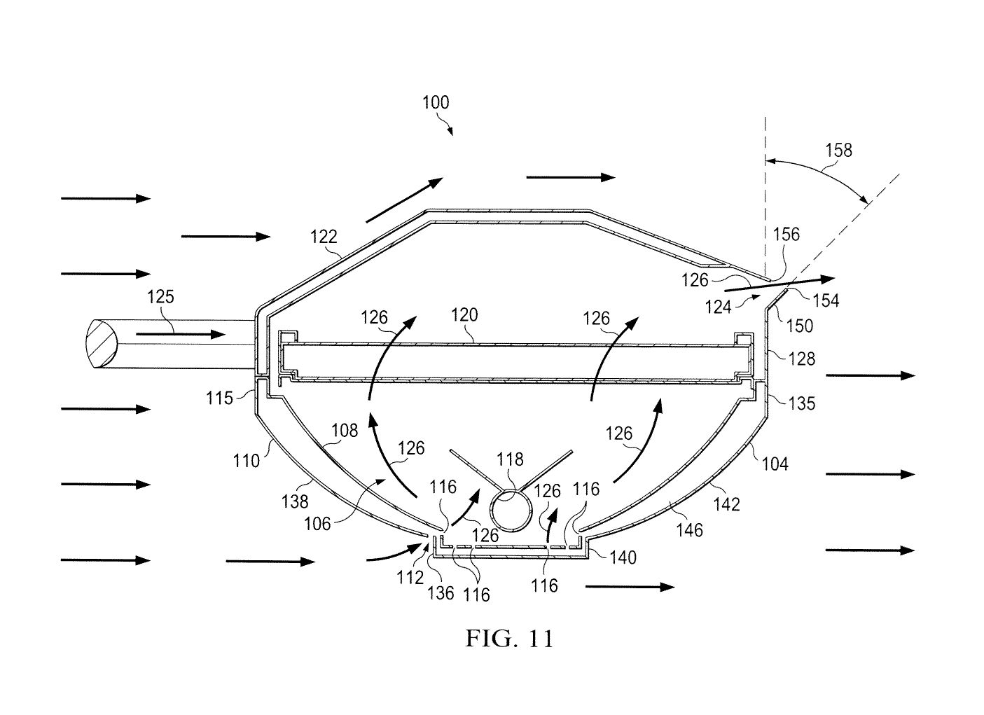

FIG. 11 illustrates the effect of a 5 mile per hour or greater, or 10 mile per hour or greater, front wind 125 on the operation of the inventive grill 100 with the cover 122 closed. In contrast to the performance of the prior art grill 2 when subjected to a front wind of this nature, the inventive grill 100 continues to maintain a greater pressure below the burner element 118 than above the burner element 118 (i.e., a pressure reversal is prevented) so that, as shown in FIG. 11 by the air and gas circulation arrows 126, secondary combustion air continues to properly flow into the air inlet opening(s) 112, the hot combustion gas produced by the burner element 118 continues to properly flow upwardly through the cooking grate 120, and the grill exhaust gases continue to properly flow out of the rear exhaust opening 124. Moreover, the inventive grill 100 will preferably continue to properly operate in this manner when subject to a front wind of up to as much as 20 miles per hour or more and most preferably up to as much as 25 miles per hour or more.

As used herein and in the claims the term “average highest normal cooking energy input level” refers to the average cooking energy input level for the grilling apparatus at its highest cooking setting or highest normal cooking temperature operation in dry weather conditions at an ambient temperature of 70° F. with no wind. Consequently, in the case of a gas burner having high, medium and low settings, the average highest normal cooking energy input level for the gas burner will be the high setting. On the other hand, in the case of a gas burner having only a single cooking setting, the average highest normal cooking energy input level for the burner will be at the single setting.

Alternatively, or preferably in addition to all of the improvements discussed above, the inventive grilling apparatus 100 shown in FIGS. 10-12 also differs from the prior art grilling apparatus 2 in that a wind diverting structure 150 is provided on the back of the inventive grill 100 at the rear exhaust opening 124. The wind diverting structure 150 preferably extends upwardly from the substantially vertical back wall 128 of the housing structure 104 at an outward angle such that the rear exhaust opening 124 extending across the back side of the grill 100 is defined between the outer edge 154 of the wind diverting structure and a rearward edge 156 of the cover 122. The configuration and orientation of the wind diverting structure 150 are preferably such that when (a) the cooking grill 100 is operated at its average highest normal cooking energy input level, (b) the cover 122 is closed (and preferably also when the cover 122 is open), and (c) a 10 mile per hour rear wind is blowing against and directly perpendicular to the rear side 135 of the cooking grill 100, the wind diverting structure 150 will be effective for causing a lower pressure to exist at the rear exhaust opening 124 than at the air inlet opening(s) 112. Thus, at the same time, the wind diverting structure 150 will be effective for causing a lower pressure to exist in the firebox 106 above the fuel delivery or fuel placement structure(s) 118 than exists elevationally below the fuel delivery or placement structure(s) 118, or at least below the gas ports 144 thereof in the case of a gas burner element.

Moreover, the configuration and orientation of the wind diverting structure 150 combined with the location(s) of the air inlet opening(s) 112 in the housing structure 104 are preferably such that a positive pressure differential (i.e., a higher pressure in the firebox 106 elevationally below the fuel delivery or fuel placement structure(s) 118 (or at least elevationally below the gas ports 144 thereof) than elevationally above the fuel structure 118 or ports 144) will be maintained regardless of whether the cover 122 is open or closed when operating under either a 10 mile per hour front wind or a 10 mile per hour rear wind.

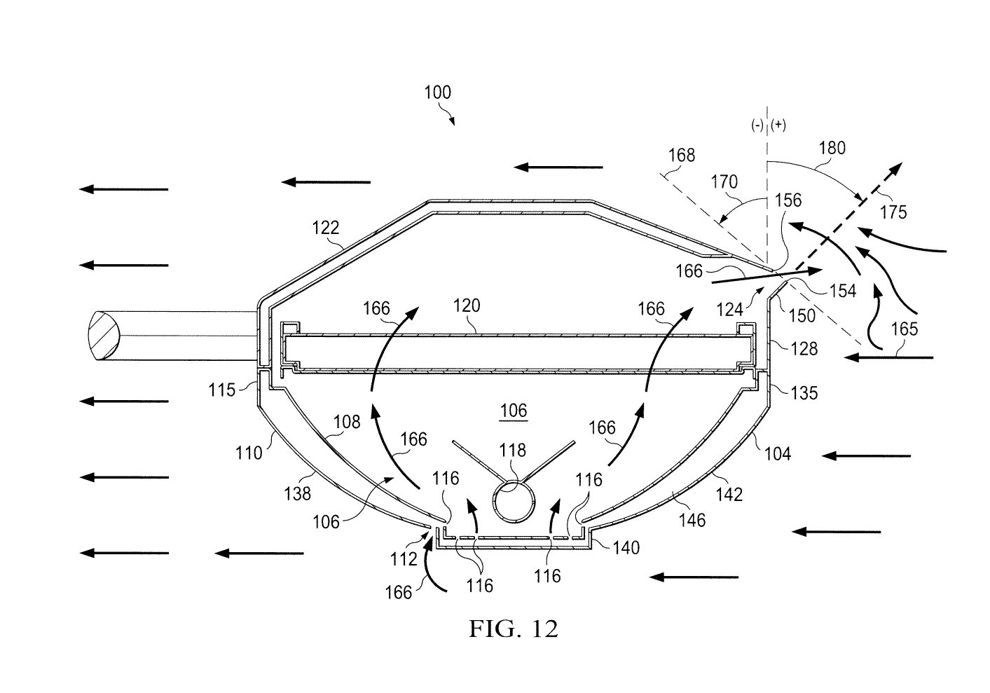

FIG. 12 illustrates the effect of a 5 mile per hour or greater, or 10 mile per hour or greater, rear wind 165 on the operation of the inventive grill 100 with the cover 122 closed. In contrast to the performance of the prior art grill 2 when subjected to a rear wind of this nature, the inventive grill 100 continues to maintain a greater pressure below the burner element 118 than above the burner element 118 (i.e., a pressure reversal is prevention) so that, as shown in FIG. 12 by the air and gas circulation arrows 166, secondary combustion air continues to properly flow into the air inlet opening(s) 112, the hot combustion gas produced by the burner element 118 continues to properly flow upwardly through the cooking grate 120, and the grill exhaust gases continue to properly flow out of the rear exhaust opening 124. Moreover, the inventive grill 100 will preferably continue to properly operate in this manner when subjected to a rear wind of up to as much as 20 miles per hour and most preferably up to as much as 25 miles per hour.

Although other orientations and configurations of the wind diverting structure 150 are possible, it is preferred that (a) the wind diverting structure 150 be a flat element which extends horizontally across the back side of the inventive grill 100 and (b) the outward angle 158 of the wind diverting structure 150 be at least 10° from vertical. The outward angle 158 of the wind diverting structure will more preferably be in the range of from about 20° to about 60° and will most preferably be from about 30° to about 50° from vertical.

As another alternative, and preferably in addition to some or all of the improvements discussed above, the inventive grilling apparatus 100 preferably differs from the prior art grilling apparatus 2 in that, regardless of whether a wind diverter structure 150 is used, the rear exhaust opening 124 is oriented at an upward angle. Specifically, the grill housing structure 104 and the lid 122 are preferably configured as illustrated in FIG. 12 such that the line 168 defining the face of the exhaust opening 124 which extends from the outer edge 154 of the wind diverter structure 150 (or from the top edge of the back wall 128 if no diverter structure is used) to the rearward edge 156 of the cover will be oriented at a forward angle 170 of as much as 90° or more from vertical. The forward angle 170 of line 168 will more preferably be from about 30° to about 80°, more preferably from about 40° to about 70°, from vertical. Consequently, the rear exhaust opening 124 will face upwardly in a direction 175, which is perpendicular to line 168, at a rearward angle 180 of as little as 0° from vertical. The rearward angle 180 of the upwardly facing rear exhaust opening faces will preferably be from about 10° to about 60°, more preferably from about 20° to about 50°, and most preferably from about 30° to about 45°, from vertical.

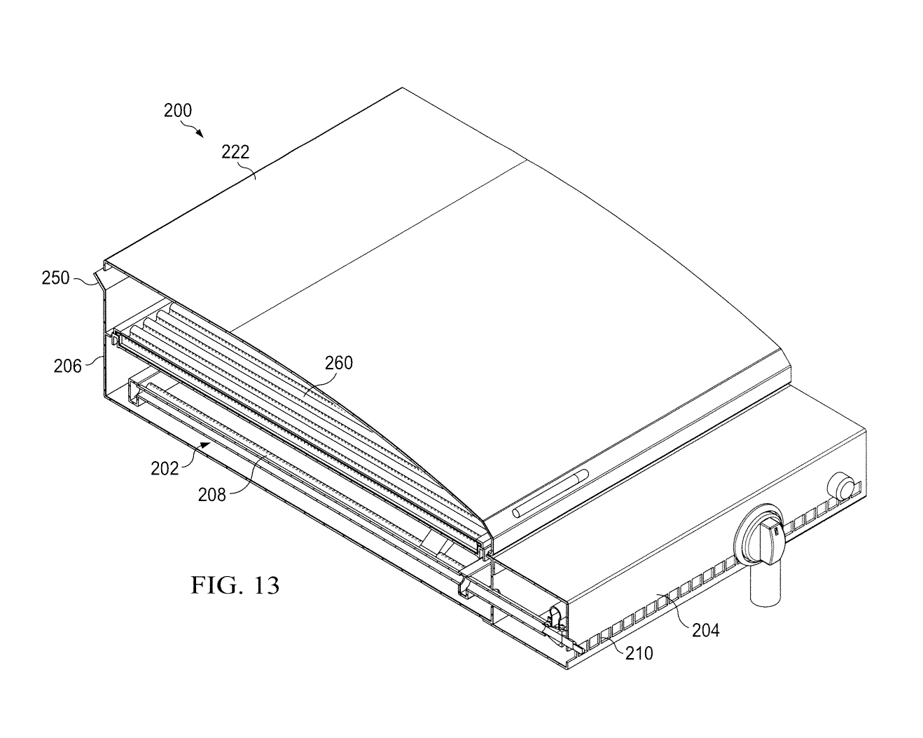

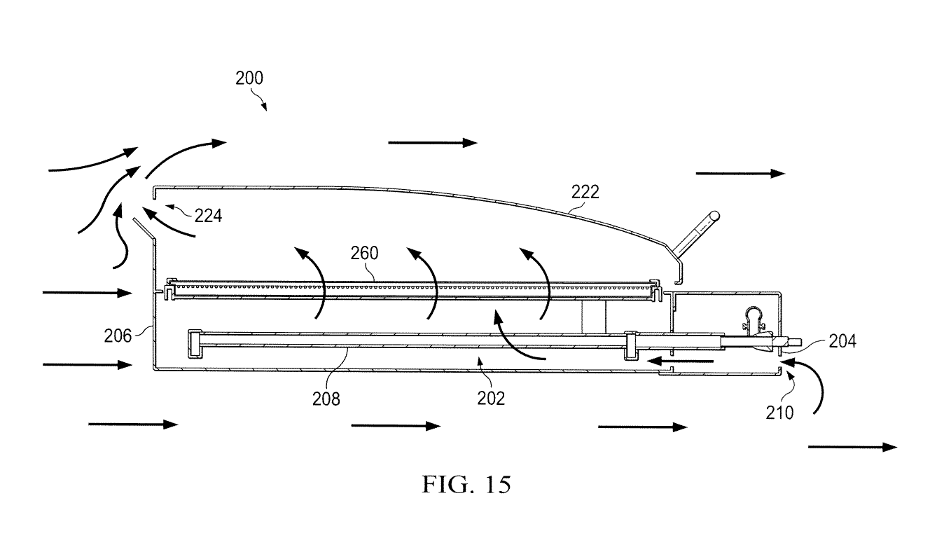

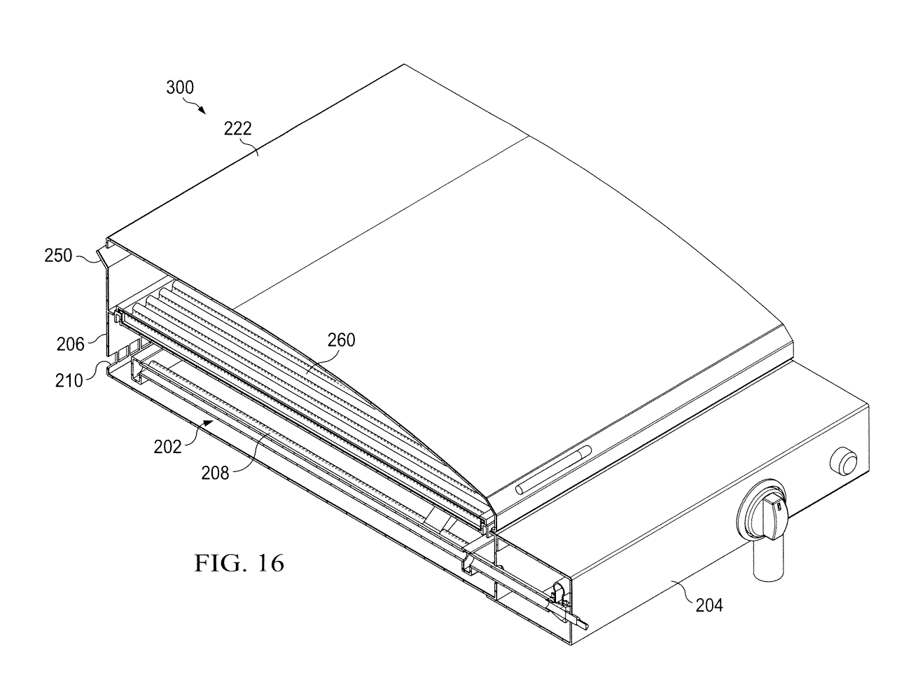

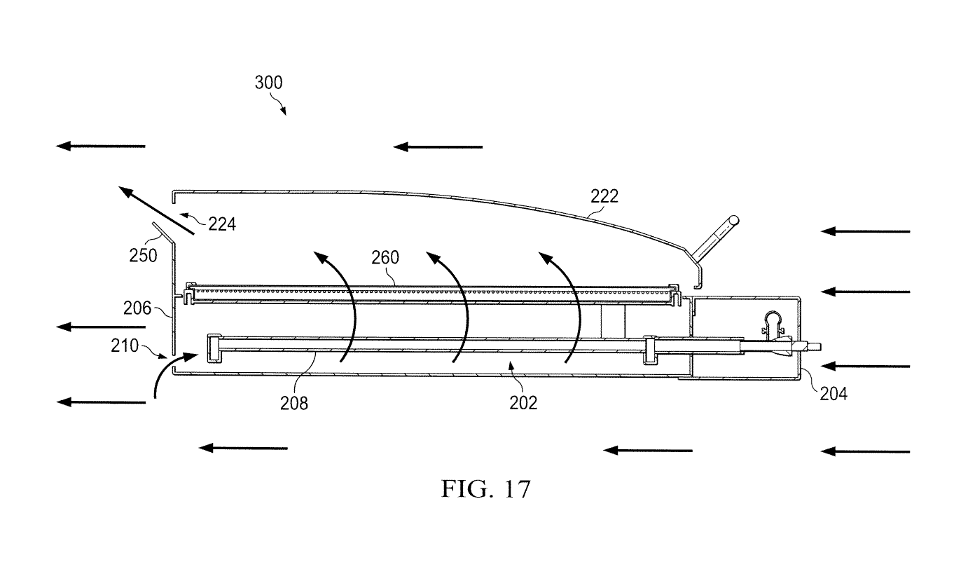

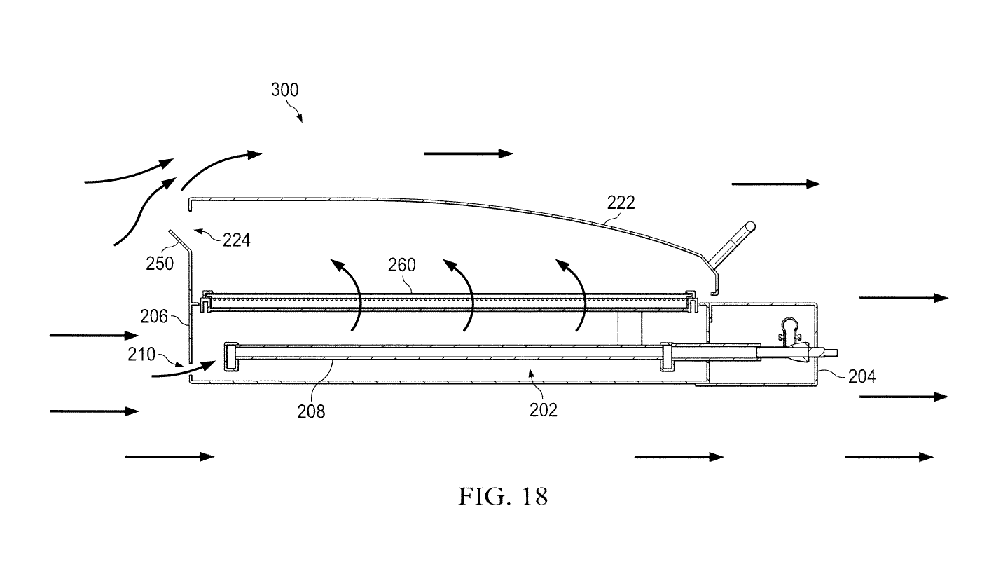

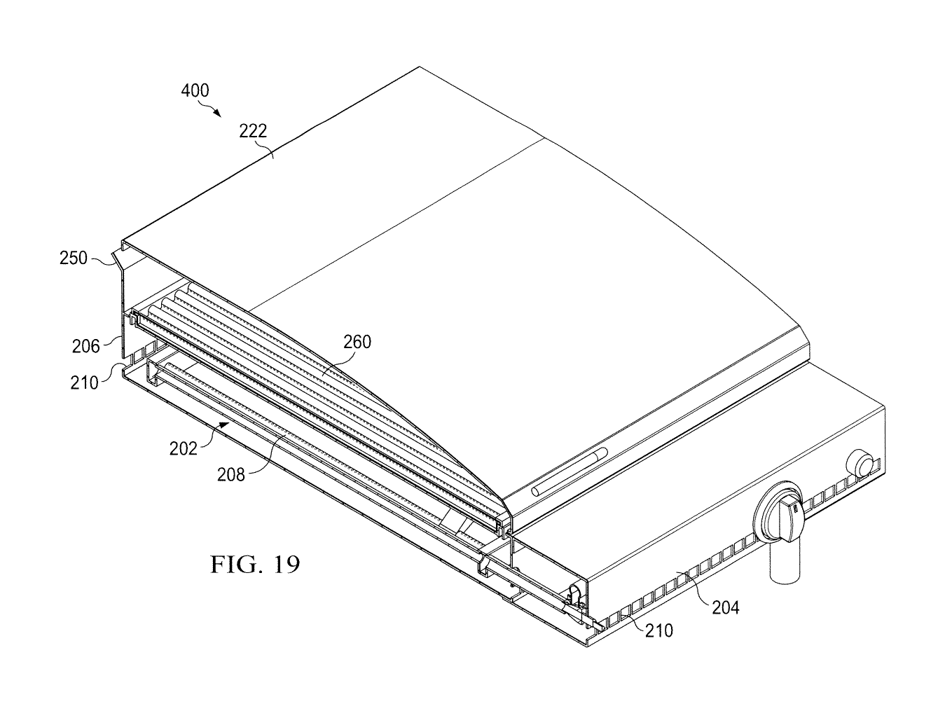

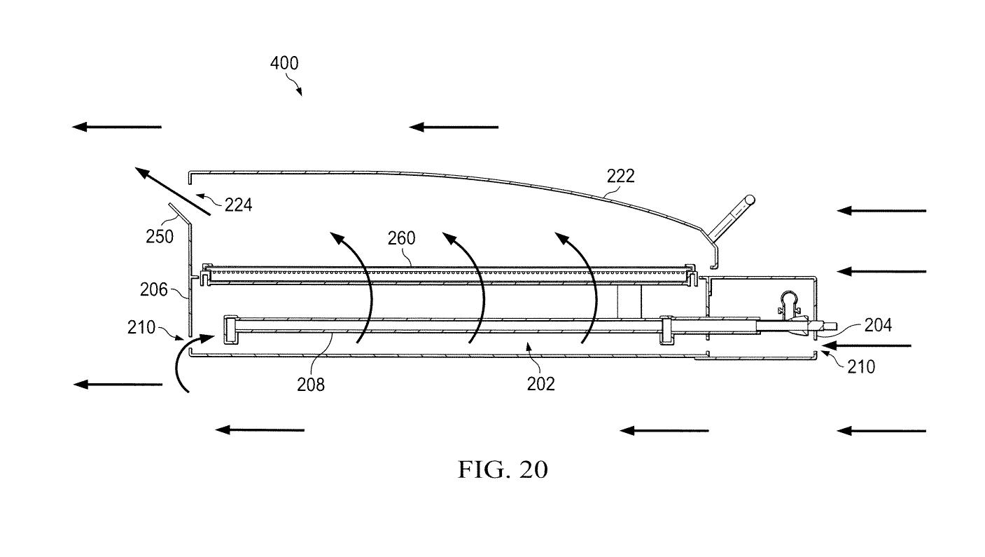

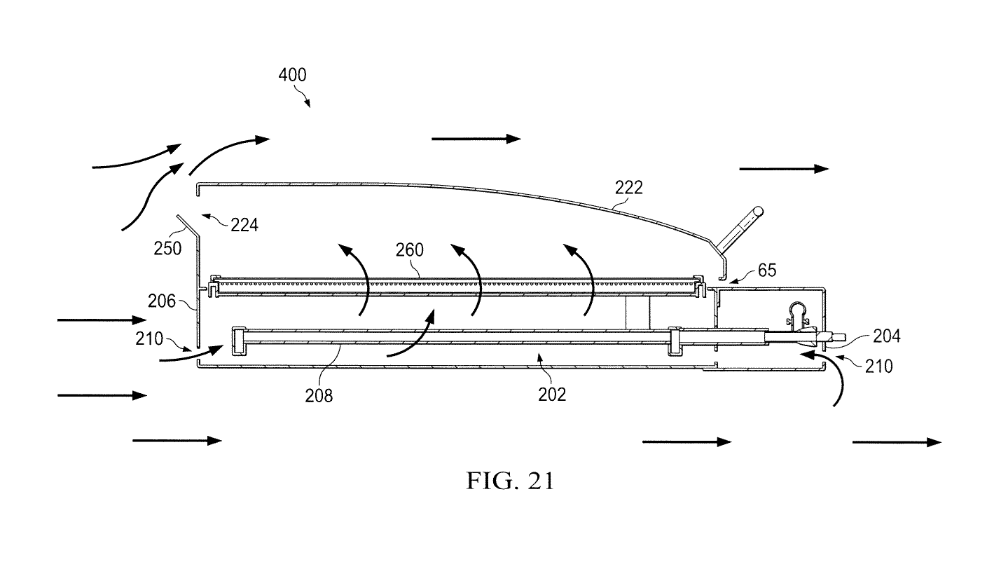

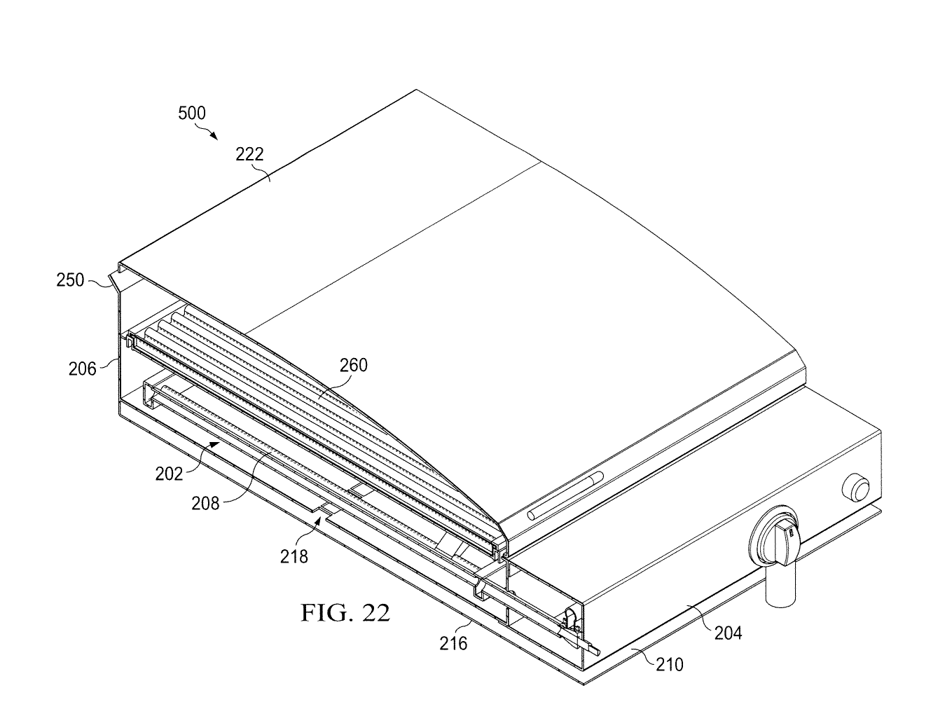

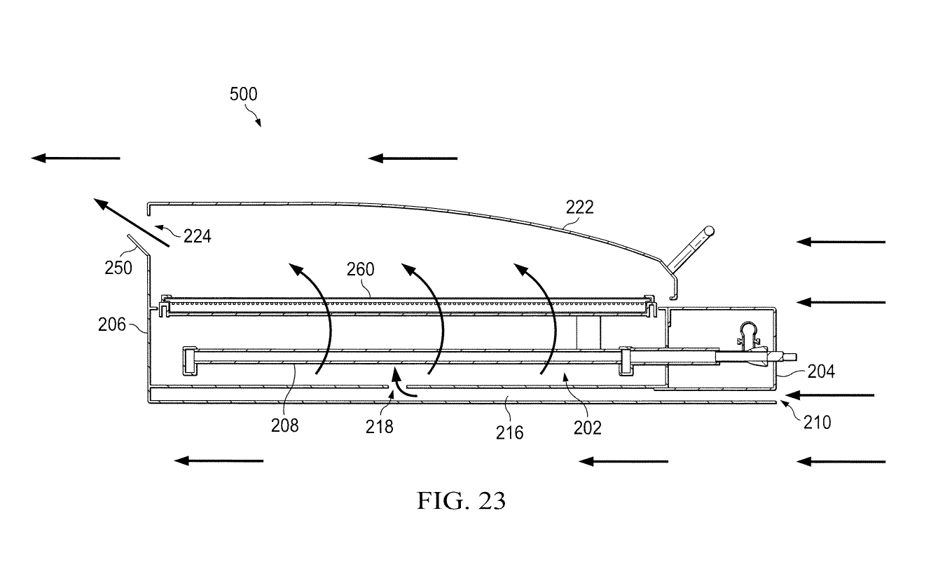

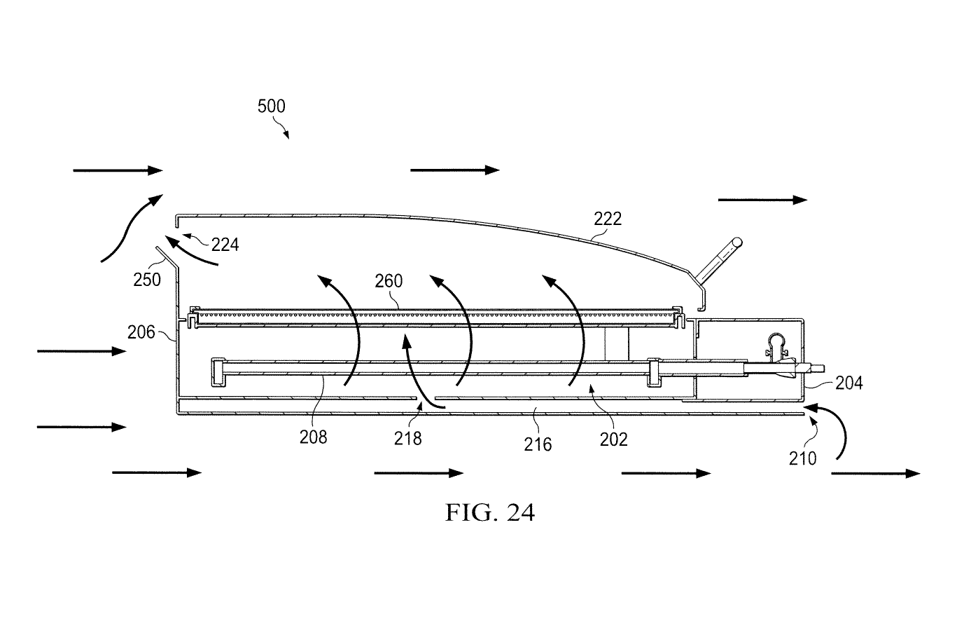

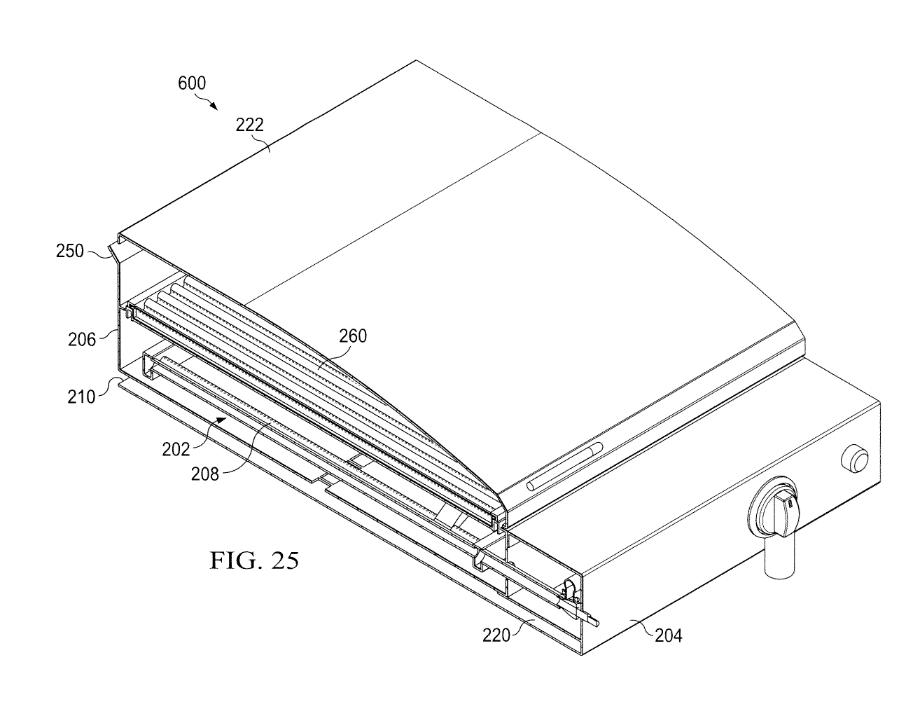

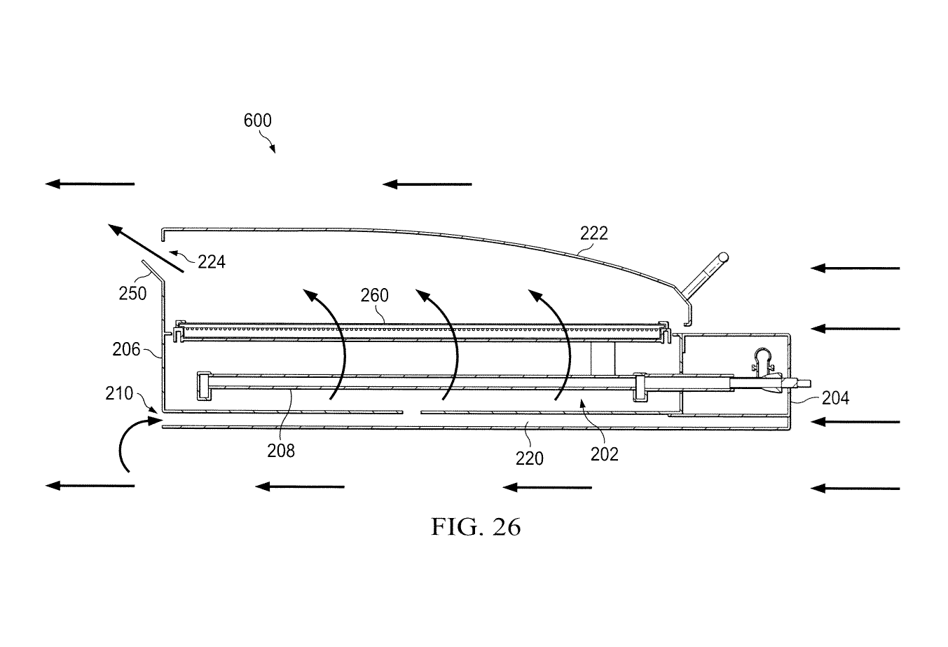

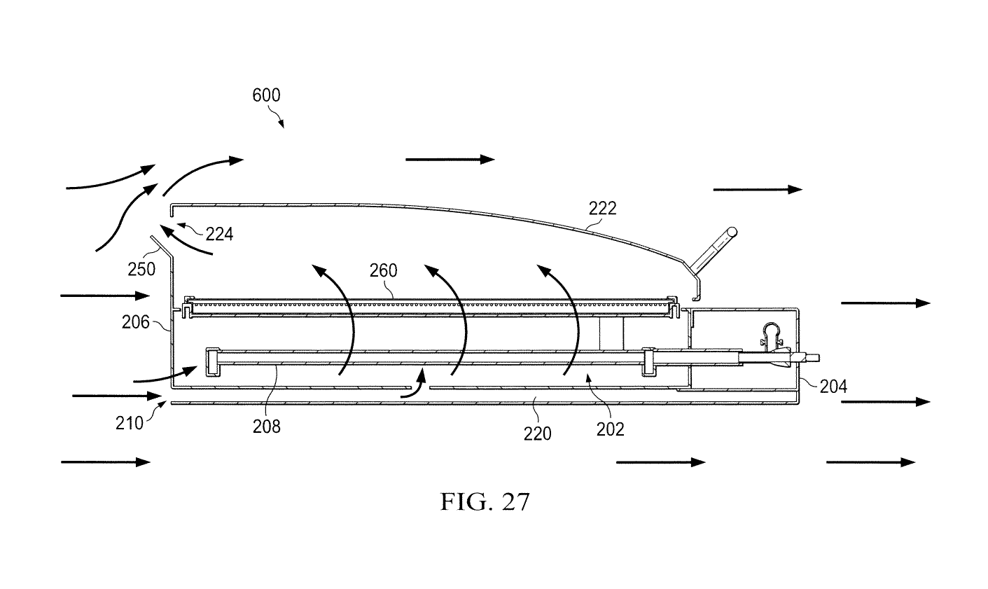

Alternative embodiments 200, 300, 400, 500, and 600 of the inventive grilling apparatus are illustrated in FIGS. 13-27. Each of these embodiments provides significant inventive improvements to the prior art grill 50 described above and includes an inventive wind diverting structure 250 and an inventive angled rear exhaust opening 224 of the same type described above. In contrast to inventive embodiment 100, each of the inventive embodiments 200, 300, 400, 500, and 600 has a more box-shaped firebox 202 which, with the partial exception of grills 500 and 600, is formed at least primarily of a single wall and has substantial vertical front and rear sides 204, and 206. Each of embodiments 200, 300, 400, 500, and 600 also preferably includes one or more burner element(s) 208 which is/are positioned in the firebox 202 such that the burner element(s) 208 extend directionally from front to back.

Each of the inventive grills 200, 300, 400, 500, and 600 has one or more air inlets 210 which is/are positioned elevationally below and horizontally forward and/or horizontally rearward of the burner element 208, or at least the fuel ports thereof, and which face forwardly and/or rearwardly at an angle which is within a range of from plus or minus 45° from horizontal. More preferably, each of the air inlets 210 of the embodiments 200, 300, 400, 500, and 600 faces forwardly and/or rearwardly at an angle which is within plus or minus 10° from horizontal and which is most preferably substantially horizontal.

In inventive grill 200, the air inlet opening(s) 210 is/are provided in the substantially vertical front wall 204 of the firebox 202 such that outside air flowing through the front opening(s) 210 will be directly received in the firebox 202. In inventive grill 300, the air inlet opening(s) 210 is/are provided in the substantially vertical rear wall 206 of the firebox 202 such that outside air flowing through the rear opening(s) 210 will be directly received in the firebox 202. Inventive grill 400 is a combination of embodiments 200 and 300 having both front and rear air inlets 112 through which outside air will be directly received in the firebox 202.

In the inventive grill 500, the air inlet 210 is provided on the front side 204 of the firebox housing structure at the mouth of an inlet air receiving structure (e.g., an inlet air duct) 216 which extends beneath the bottom of the firebox 202 and is in fluid communication with one or more firebox bottom opening(s) 218. Consequently, outside air received by the air inlet 210 flows into the firebox 202 via the inlet air duct 216 and the firebox bottom opening(s) 218.

The inventive grill 600 is similar to the inventive grill 500 except that the air inlet opening(s) 210 of grill 600 is/are provided at the rearward mouth of an inlet air duct 220 which extends beneath the firebox 202 to the rear side 206 of the grill 600.

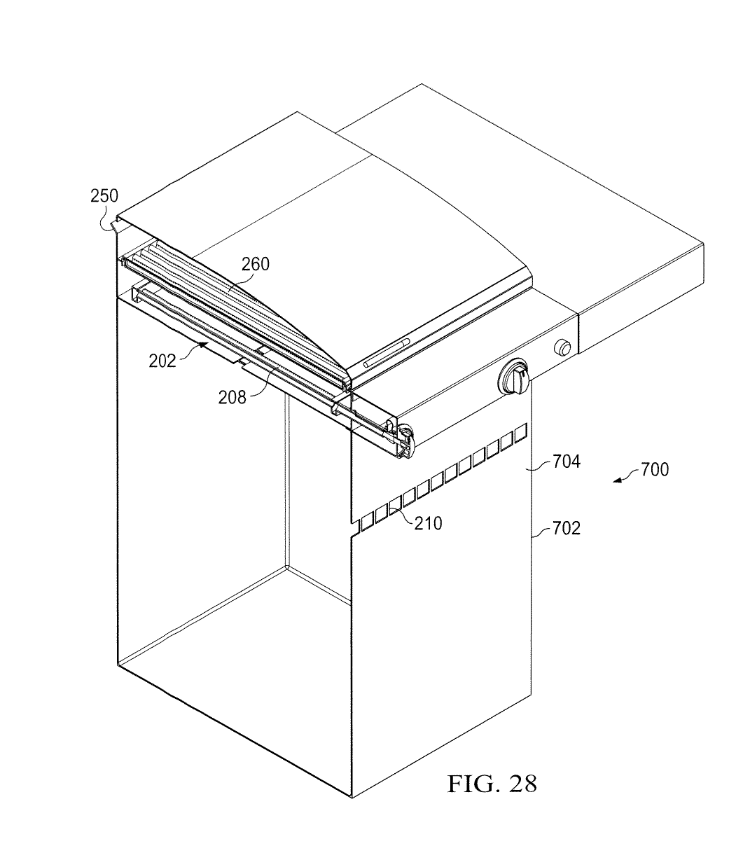

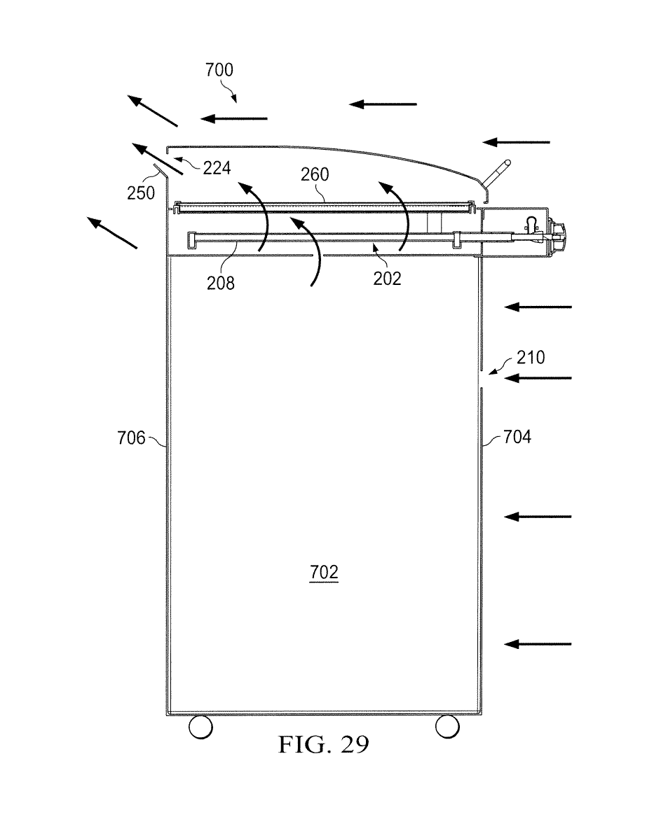

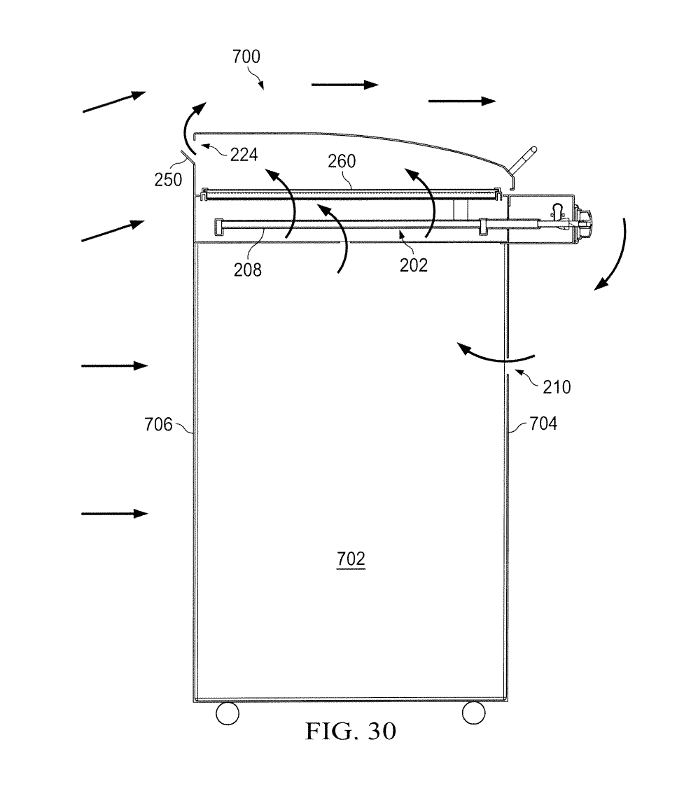

Yet another embodiment 700 of the inventive grilling apparatus is illustrated in FIGS. 28-30. The grilling apparatus 700 is similar to the prior art grill and cart apparatus 80 described above except that (a) the inventive grill 700 includes a wind diverter structure 250 and (b) the inventive grill 700 also includes air inlet openings 210 across the vertical front face 704 of the cabinet 702 so that the cabinet 702 operates as an inlet air receiving structure. The inventive grill 700 thus operates and performs in a manner similar to the inventive grill 500. It will also be understood that the inlet air opening(s) 210 could be provided across the vertical rear face 706 of the cart box 702 or across both the front face 704 and the rear face 706.

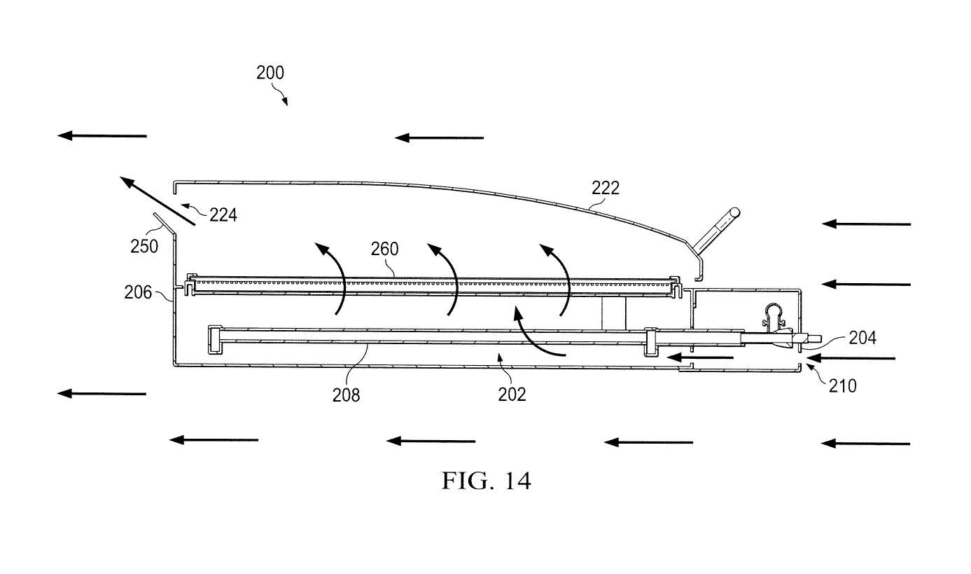

The air and gas circulation arrows provided in FIGS. 14, 15, 17, 18, 20, 21, 23, 24, 26, 27, 29, and 30 illustrate the improved operation of the inventive grilling apparatuses 200, 300, 400, 500, 600, and 700 when subjected to front or rear winds of 5 miles per hour or greater or 10 miles per hour or greater. In contrast to the performance of the prior art grills 50 and 80 when subjected to front or rear winds of this nature, the inventive grills 200, 300, 400, 500, 600, and 700 continue to maintain a greater pressure in the firebox 202 below the burner element(s) 208, or at least the ports thereof, so that secondary combustion air continues to properly flow into the air inlet opening(s) 210, the hot combination gases produced by the burner element(s) 208 continue properly flow upwardly through the grate or other food support structure 260, and the grill exhaust gases continue to properly flow out of the rear exhaust opening 224. Moreover, the inventive grills 200, 300, 400, 500, 600, and 700 will preferably continue to operate in this manner when subjected to a front or rear wind of up to as much as 20 miles per hour or more and most preferably up to as much as 25 miles per hour or more.

### Example

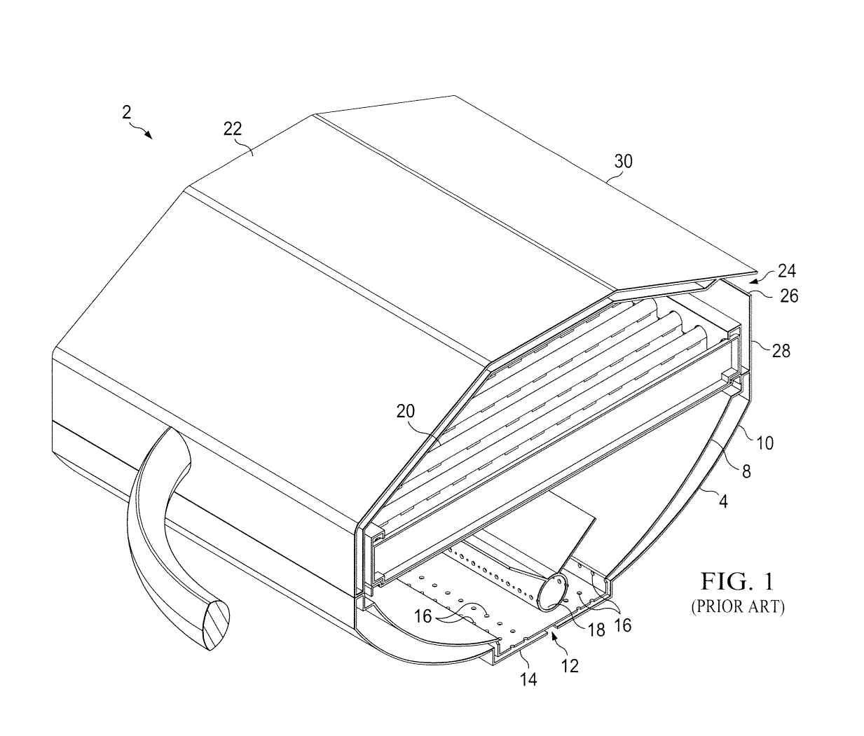

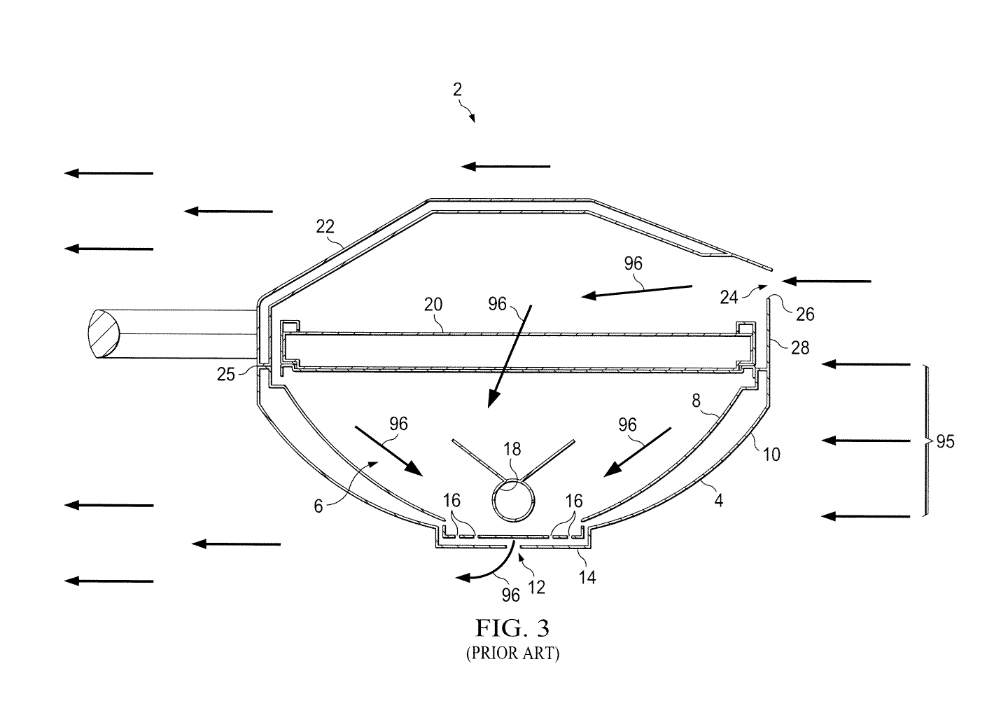

Computer simulations of the prior art grilling apparatus 2 illustrated in FIG. 1-3 and the inventive grilling apparatus 100 illustrated in FIG. 10-12 show that: (a) if each of these grills is operated at a gas fuel rate which would otherwise provide a grate temperature of 650° F. under dry conditions at an ambient temperature of 70° F. and no wind and (b) each of these grills is then subjected to a perpendicular front wind of 10 miles per hour and a perpendicular rear wind of 10 miles per hour, the results will be as indicated below in Table 1. In addition, Table 1 also shows what the separate results will be for an inventive grill having either (a) a front air opening but no wind diverter or (b) a wind diverter but no front air opening.

TABLE 1

| | | | | | Ave Food | | | | |
|---|---|---|---|---|---|---|---|---|---|
| | LID CLOSED | | | | Chamber | LID OPEN | | | |
| | Inlet | | Exhaust | | Temp | | | Exhaust | |
| | Gauge | Gas Flow | Gauge_Press | Ave Grate | Above | Inlet Gauge Press | Gas Flow | Gauge Press | Ave Grate |
| | Press (Pa) | Direction | (Pa) | Temp (° F.) | Grate (° F.) | (Pa) | Direction | (Pa) | Temp (° F.) |
| Prior Art Grill 2 | −1.81 | Down | 7.43 | 360 | 170 | −1.23 | Down | −0.07 | 591 |
| (Rear Wind) | | | | | | | | | |
| Prior Art Grill | −6.85 | Down | −4.19 | 723 | 418 | 8 | Down | 13 | 396 |
| 2 (Front Wind) | | | | | | | | | |
| Inventive Grill 100 | −8.8 | Up | −15.4 | 747 | 750 | −.14 | Up | −.16 | 677 |
| (Rear Wind) | | | | | | | | | |
| Inventive Grill 100 | 8.48 | Up | −4.05 | 712 | 733 | 17 | Up | 12 | 641 |
| (Front Wind) | | | | | | | | | |
| Diverter but No | −10.5 | Up | −14.0 | 712 | 617 | −1.23 | Down | −.07 | 591 |
| Front Air Opening | | | | | | | | | |
| (Rear Wind) | | | | | | | | | |
| Diverter but No | −6.85 | Down | −4.19 | 723 | 418 | 8 | Down | 13 | 396 |
| Front Air Opening | | | | | | | | | |
| (Front Wind) | | | | | | | | | |
| Front Air Opening | −5.74 | Down | 9.21 | 577 | 278 | −.14 | Up | −.16 | 677 |
| but No Diverter | | | | | | | | | |
| (Rear Wind) | | | | | | | | | |
| Front Air Opening | 8.48 | Up | −4.05 | 712 | 733 | 17 | Up | 12 | 641 |
| but No Diverter | | | | | | | | | |
| (Front Wind) | | | | | | | | | |

As these simulation results indicate, the prior art grill 2 will experience a pressure reversal in each case, regardless of whether the cover is open or closed and regardless of whether the wind is against the front or the back of the grill. Consequently, the gas flow through the food support structure of the prior art grill 2 will be downward rather than upward.

In contrast, the simulation results provided in Table 1 show that: (a) the use of a front side air inlet 112 in accordance with the present invention as illustrated in FIGS. 10-12 will cause the combustion gas to continue to flow upwardly through the food support grate 120 in the case of a front wind, regardless of whether the cover is closed or open, and in the case of a rear wind when the cover 122 is open, (b) the inventive wind diverting structure 150 will cause the combustion gases to continually flow upwardly through the food support grate 120 with the cover 122 closed when subjected to a rear wind of 10 miles per hour, and (c) the inventive wind diverting structure 150 and an inventive front air inlet location 112, in combination, will cause the combustion gases produced in the inventive grill 100 to continue to flow upwardly through the food support structure 120 when subjected to either a 10 mile per hour front wind or a 10 mile per hour rear wind, regardless of whether the cover 122 is open or closed.

In addition, actual cooking tests conducted on the inventive grill 100 and the prior art grill 2 under 10 mile per hour winds showed that the temperature at the cooking grate of the prior art grill 2 was so impaired that the required cooking time was more than tripled and the prior art grill 2 was substantially unable to leave sear marks on the food. In contrast, however, the cooking temperature at the grate of the inventive grill 100 was from 100 F.° to 200° F. higher and good sear marks were produced on the food.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the invention as defined by the claims.

What is claimed is:

1. In a grilling apparatus comprising:
a housing structure having therein an upwardly facing firebox;
a cover for opening and closing said firebox;
a fuel delivery or placement structure in said firebox; and
an air inlet provided in an outermost wall of said housing structure for receiving outside air such that said outside air flowing into said air inlet will be delivered into said firebox,
wherein said grilling apparatus has a front side and a rear side and, when said cover is closed, said grilling apparatus has a rear exhaust opening,
the improvement comprising said air inlet being comprised of one or more inlet air openings in said outermost wall oriented in a manner and positioned forwardly, rearwardly, or both forwardly and rearwardly of said fuel delivery or placement structure in a manner effective such that, when said grilling apparatus is operated at an average highest normal cooking energy input level for said grilling apparatus, said cover is closed, and a 10 mile per hour front wind is blowing against and directly perpendicular to said front side of said grilling apparatus, a greater pressure will exist in said firebox elevationally below said fuel delivery or placement structure than will exist in said firebox above said fuel delivery or placement structure.

2. The grilling apparatus of claim 1 wherein the improvement further comprises said one or more inlet air openings also being positioned in a manner effective such that, when said grilling apparatus is operated at said average highest normal cooking energy input level for said grilling apparatus, said cover is open, and a 10 mile per hour front wind is blowing against and directly perpendicular to said front side of said grilling apparatus, a greater pressure will exist in said firebox elevationally below said fuel delivery or placement structure than will exist in said firebox above said fuel delivery or placement structure.

3. The grilling apparatus of claim 1 wherein said fuel delivery or placement structure is a gas burner.

4. The grilling apparatus of claim 1 wherein said fuel delivery or placement structure is a solid fuel placement structure.

5. The grilling apparatus of claim 1 wherein the improvement further comprises said one or more inlet air openings being at least partially forwardly facing, at least partially rearwardly facing, or both at least partially forwardly facing and at least partially rearwardly facing.

6. The grilling apparatus of claim 5 wherein the improvement further comprises said one or more inlet air openings facing forwardly, rearwardly, or both forwardly and rearwardly at an orientation within a range of plus or minus 45° from horizontal.

7. The grilling apparatus of claim 1 wherein the improvement further comprises said firebox having only a single upwardly extending front wall and a single upwardly extending rear wall and said outermost wall being said single upwardly extending front wall, said single upwardly extending rear wall, or both said single upwardly extending front wall and said single upwardly extending rear wall of said firebox such that said outside air flowing into said inlet air openings will be directly received in said firebox.

8. The grilling apparatus of claim 1 wherein the improvement further comprises:
said firebox having a firebox inner wall and said outermost wall covering at least a portion of an exterior of said firebox inner wall such that an air flow gap is formed between said firebox inner wall and said outermost wall;
said one or more inlet air openings in said outermost wall are in fluid communication with said air flow gap; and
one or more openings are provided through said firebox inner wall in fluid communication with said air flow gap for receiving said outside air which flows through said one or more inlet air openings and said air flow gap.

9. The grilling apparatus of claim 1 wherein the improvement further comprises a wind diverting structure which extends upwardly and outwardly on a rear side of said housing structure in a manner effective such that said rear exhaust opening is defined between an outer end of said wind diverting structure and an edge of said cover and, when said grilling apparatus is operated at said average highest normal cooking energy input level for said grilling apparatus, said cover is closed, and a 10 mile per hour rear wind is blowing against and directly perpendicular to said rear side of said grilling apparatus, a greater pressure will exist in said firebox elevationally below said fuel delivery or placement structure than will exist in said firebox above said fuel delivery or placement structure.

10. In a grilling apparatus comprising:
a housing structure having therein an upwardly facing firebox;
a cover for opening and closing said firebox;
a fuel delivery or placement structure in said firebox; and
an air inlet provided in an outermost wall of said housing structure for receiving outside air such that said outside air flowing into said air inlet will be received in said firebox,
wherein said grilling apparatus has a front side and a rear side and, when said cover is closed, said grilling apparatus has a rear exhaust opening,
the improvement comprising said air inlet of said housing structure being comprised of one or more inlet air openings facing forwardly, rearwardly, or both forwardly and rearwardly at an orientation within a range of plus or minus 45° from horizontal.

11. The grilling apparatus of claim 10 wherein said fuel delivery or placement structure is a gas burner.

12. The grilling apparatus of claim 10 wherein the improvement further comprises said firebox having only a single upwardly extending front wall and a single upwardly extending rear wall and said outermost wall being said single upwardly extending front wall, said single upwardly extending rear, or both said single upwardly extending front wall and said single upwardly extending rear wall of said firebox such that said outside air flowing into said one or more inlet air openings will be directly received in said firebox.

13. The grilling apparatus of claim 10 wherein the improvement further comprises:
said firebox having a firebox inner wall and said outermost wall covering at least a portion of an exterior of said firebox inner wall such that an air flow gap is formed between said firebox inner wall and said outermost wall;
said one or more inlet air openings in said outermost wall are in fluid communication with said air flow gap; and
one or more openings are provided through said firebox inner wall in fluid communication with said air flow gap for receiving said outside air which flows through said one or more inlet air openings and said air flow gap.

14. The grilling apparatus of claim 10 wherein the improvement further comprises a wind diverting structure which extends upwardly and outwardly on a rear side of said housing structure in a manner effective such that said rear exhaust opening is defined between an outer end of said wind diverting structure and an edge of said cover and, when said grilling apparatus is operated at said average highest normal cooking energy input level for said grilling apparatus, said cover is closed, and a 10 mile per hour rear wind is blowing against and directly perpendicular to said rear side of said grilling apparatus, a greater pressure will exist in said firebox elevationally below said fuel delivery or placement structure than will exist in said firebox above said fuel delivery or placement structure.

15. In a grilling apparatus comprising:
a housing structure having therein an upwardly facing firebox;
a cover for opening and closing said firebox;
a burner element in said firebox, said burner element having a plurality of gas discharge ports; and
an air inlet provided in an outermost wall of said housing structure for receiving outside air such that said outside air flowing into said air inlet will be received in said firebox,
wherein said grilling apparatus has a front side and a rear side and, when said cover is closed, said grilling apparatus has a rear exhaust opening,
the improvement comprising said air inlet being comprised of one or more inlet air openings positioned in an upwardly extending portion of a front side of said housing structure and being positioned elevationally lower than said gas discharge ports such that, when said grilling apparatus is operated at a highest cooking setting for said burner element, said cover is closed, and a 10 mile per hour front wind is blowing against and directly perpendicular to said front side of said grilling apparatus, a greater pressure will exist in said firebox elevationally below said gas discharge ports than will exist in said firebox above said gas discharge ports and
the improvement further comprises a wind diverting structure which extends upwardly and outwardly on a rear side of said housing structure in a manner effective such that said rear exhaust opening is defined between an outer end of said wind diverting structure and an edge of said cover and, when said grilling apparatus is operated at said highest cooking setting for said burner element, said cover is closed, and a 10 mile per hour rear wind is blowing against and directly perpendicular to said rear side of said grilling apparatus, a greater pressure will exist in said firebox elevationally below said gas discharge ports than will exist in said firebox above said gas discharge ports.

16. The grilling apparatus of claim 15 wherein the improvement further comprises said rear exhaust opening being defined between said outer end of said wind diverting structure and said edge of said cover in a manner such that, when said cover is closed, said rear exhaust opening faces upwardly at a rearward angle of from about 10° to about 60° from vertical.

17. The grilling apparatus of claim 16 wherein the improvement further comprises said rearward angle being from about 20° to about 50° from vertical.

18. In a grilling apparatus comprising a housing structure having an upwardly facing firebox and said grilling apparatus also comprising a cover for opening and closing said firebox and a fuel delivery or placement structure in said firebox, and wherein said grilling apparatus has a front side and a rear side and, when said cover is closed, said grilling apparatus has a rear exhaust opening, the improvement comprising:
a wind diverting structure which extends upwardly on a rear side of said housing structure at an outward angle;
said outward angle being in a range of from about 20° to about 60° from vertical; and
said rear exhaust opening being defined between an outer end of said wind diverting structure and an edge of said cover such that said rear exhaust opening faces upwardly at a rearward angle of from about 10° to about 60° from vertical.

19. The grilling apparatus of claim 18 wherein the improvement further comprises said rear exhaust opening facing upwardly at a rearward angle of from about 20° to about 50° from vertical.

20. The grilling apparatus of claim 18 wherein the improvement further comprises said wind diverting structure being effective such that when said grilling apparatus is operated at an average highest normal cooking energy input level for said grilling apparatus, said cover is closed, and a 10 mile per hour rear wind is blowing against and directly perpendicular to said rear side of said grilling apparatus, a greater pressure will exist in said firebox elevationally below said fuel delivery or placement structure than will exist in said firebox above said fuel delivery or placement structure.

21. The grilling apparatus of claim 18 further comprising an air inlet provided in an outermost wall of said housing structure for receiving outside air such that said outside air flowing into said air inlet is delivered into said firebox, wherein the improvement further comprises said air inlet being comprised of one or more inlet air openings located and oriented on a front side of said housing structure in a manner effective such that, when said grilling apparatus is operated at an average highest normal cooking energy input level for said grilling apparatus, said cover is closed, and a 10 mile per hour front wind is blowing against and directly perpendicular to said front side of said grilling apparatus, a greater pressure will exist in said firebox elevationally below said fuel delivery or placement structure than will exist in said firebox above said fuel delivery or placement structure.

22. The grilling apparatus of claim 21 wherein the improvement further comprises said one or more inlet air openings also being positioned in a manner effective such that, when said grilling apparatus is operated at said average highest normal cooking energy input level for said grilling apparatus, said cover is open, and a 10 mile per hour front wind is blowing against and directly perpendicular to said front side of said grilling apparatus, a greater pressure will exist in said firebox below said fuel delivery or placement structure than will exist in said firebox above said fuel delivery or placement structure.

23. The grilling apparatus of claim 21 wherein the improvement further comprises said firebox having only a single upwardly extending front wall and said outermost wall being said single upwardly extending front wall of said firebox such that said outside air flowing into said one or more inlet air openings will be directly received in said firebox.

24. The grilling apparatus of claim 21 wherein the improvement further comprises:
said firebox having a firebox inner wall and said outermost wall covering at least a portion of an exterior of said firebox inner wall such that an air flow gap is formed between said firebox inner wall and said outermost wall;
said one or more inlet air openings in said outermost wall are in fluid communication with said air flow gap; and
one or more openings are provided through said firebox inner wall in fluid communication with said air flow gap for receiving said outside air which flows through said one or more inlet air openings and said air flow gap.

25. The grilling apparatus of claim 18 wherein the improvement further comprises:
an inlet air duct beneath a bottom of said firebox;
at least one opening provided in said bottom of said firebox in fluid communication with said inlet air duct; and
one or more air inlets provided in a forward end, a rearward end, or both said forward end and said rearward end of said inlet air duct for receiving outside air in a manner effective such that, when said grilling apparatus is operated at an average highest normal cooking energy input level for said grilling apparatus, said cover is closed, and a 10 mile per hour front wind is blowing against and directly perpendicular to said front side of said grilling apparatus, a greater pressure will exist in said firebox elevationally below said fuel delivery or placement structure than will exist in said firebox above said fuel delivery or placement structure.

26. The grilling apparatus of claim 18 wherein the improvement further comprises:
a box structure beneath a bottom of said firebox;
at least one opening provided in said bottom of said firebox in fluid communication with an interior of said box structure; and
one or more air inlets provided in a forward face, a rearward face, or both said forward face and said rearward face of said box structure for receiving outside air in a manner effective such that, when said grilling apparatus is operated at an average highest normal cooking energy input level for said grilling apparatus, said cover is closed, and a 10 mile per hour front wind is blowing against and directly perpendicular to said front side of said grilling apparatus, a greater pressure will exist in said firebox elevationally below said fuel delivery or placement structure than will exist in said firebox above said fuel delivery or placement structure.

27. In a grilling apparatus comprising:
a housing structure having therein an upwardly facing firebox;
a cover for opening and closing said firebox; and
a fuel delivery or placement structure in said firebox,
wherein said grilling apparatus has a front side and a rear side and, when said cover is closed, said grilling apparatus has a rear exhaust opening,
the improvement comprising:
an inlet air receiving structure beneath a bottom of said housing structure,
at least one opening provided in said bottom of said housing structure such that said opening is in fluid communication with said firebox and with said inlet air receiving structure, and
one or more front, rear, or both front and rear air inlets in said inlet air receiving structure for receiving outside air in a manner effective such that, when said grilling apparatus is operated at an average highest normal cooking energy input level for said grilling apparatus, said cover is closed, and a 10 mile per hour front wind is blowing against and directly perpendicular to said front side of said grilling apparatus, a greater pressure will exist in said firebox elevationally below said fuel delivery or placement structure than will exist in said firebox above said fuel delivery or placement structure.

28. The grilling apparatus of claim 27 wherein the improvement further comprises said inlet air receiving structure being an inlet air duct.

29. The grilling apparatus of claim 27 wherein the improvement further comprises said inlet air receiving structure being a box structure.

30. The grilling apparatus of claim 27 wherein the improvement further comprises a wind diverting structure which extends upwardly and outwardly on a rear side of said housing structure in a manner effective such that said rear exhaust opening is defined between an outer end of said wind diverting structure and an edge of said cover and, when said grilling apparatus is operated at said average highest normal cooking energy input level for said grilling apparatus, said cover is closed, and a 10 mile per hour rear wind is blowing against and directly perpendicular to said rear side of said grilling apparatus, a greater pressure will exist in said firebox elevationally below said fuel delivery or placement structure than will exist in said firebox above said fuel delivery or placement structure.
